(19) United States
(12) Patent Application Publication
(10) Pub. No.: US 2009/0136647 A1
(43) Pub. Date: May 28, 2009

(54) Method of making mashable potatoes

(75) Inventors: Linda Elaine Tiffany, Ontario, OR (US); Sharon Mikesell, New Plymouth, ID (US); Jamie Ann Thomas, Maple Valley, WA (US)

Correspondence Address: BUCHANAN, INGERSOLL & ROONEY PC, POST OFFICE BOX 1404, ALEXANDRIA, VA, 22313-1404, US

(73) Assignee: H.J. Heinz, Pittsburgh, PA (US)

(21) Appl. No.: 12/289,304

(22) Filed: Oct. 24, 2008

Related U.S. Application Data
(60) Provisional application No. 60/996,037, filed on Oct. 25, 2007.

(51) Int. Cl. A23L 1/216; B65B 25/22

(52) U.S. Cl. 426/637; 426/393; 426/302

(57) ABSTRACT

A method of making frozen, reheatable and mashable potato pieces includes fully cooking potato pieces such that the potato pieces maintain structural integrity, dewatering the potato pieces, and freezing the potato pieces and packaging the frozen potato pieces in a reheatable container to form frozen, reheatable, and mashable potato pieces.

### CROSS-REFERENCE TO RELATED APPLICATION

This application claims priority under 35 U.S.C. §119 to U.S. Provisional Application No. 60/996,037 entitled METHOD OF MAKING MASHABLE POTATOES, filed Oct. 25, 2007, the entire content of which is hereby incorporated by reference.

### BACKGROUND

Many people enjoy mashable potatoes as a side dish to meals. However, it can be inconvenient to peel, cook, and prepare the mashable potatoes because of time constraints. Previous attempts to create quick and easy mashable potatoes include the use of dehydrated potato flakes, which do not provide the taste or texture of homemade mashable potatoes.

Thus, there remains a need for quick mashable potatoes that are easy to prepare and provide the taste and texture of homemade mashable potatoes.

### SUMMARY

As provided herein, a method of making frozen, reheatable and mashable potato pieces includes: cooking potato pieces, dewatering the potato pieces, and freezing the potato pieces. In an embodiment, the method can include washing and/or scrubbing the potato pieces. Preferably, the potato pieces are peeled, unpeeled, and/or partially peeled.

In a preferred embodiment, the potato pieces are cut substantially or generally into uniform potato pieces in the form of cubes, sticks, discs, wedges, combinations thereof and the like ranging in size from about ¼ inch to about 3 inches. The substantially or generally uniform potato pieces preferably are similarly sized and/or shaped.

In an embodiment, the potato pieces are fully cooked by cooking in hot water (wet cooking) or steaming (steam cooking). Preferably, the potato pieces are cooked in a hot water bath at about 175° F. to about 190° F. for about 8 minutes to about 40 minutes. In an embodiment, the potato pieces are steamed at about 200° F. to about 280° F. for about 5 minutes to about 10 minutes. Optionally, the potato pieces can be pretreated at about 120° F. to about 135° F. for about 20 minutes to about 35 minutes. Also optionally, the potato pieces are quenched to a core temperature of about 40° F. to ambient. After cooking, the potato pieces are dewatered so that the potato pieces have a moisture content of less than about 85%. Once cooked, the potato pieces can be frozen to a temperature of less than about 10° F.

In a preferred embodiment, at least one fat system may be applied to the potato pieces. The at least one fat system is selected from the group consisting of butter, margarine, olive oil, vegetable oil, chicken stock, beef stock, fish stock, safflower oil, peanut oil, sesame oil, lard, sunflower oil and/or combinations thereof.

Preferably, at least one seasoning may be applied to the potato pieces. Preferred seasonings include salt, pepper, sugar, sugar substitutes, garlic, herbs, spices, flavored oils, combinations thereof, and the like.

In an embodiment, an individual quick frozen ingredient may be applied to the potato pieces. Preferably, the individual quick frozen ingredient(s) include at least one protein, at least one sauce and/or at least one vegetable. The at least one protein may be selected from the group consisting of beef, pork, chicken, soy protein, fish, shellfish, and combinations thereof. The at least one sauce may be selected from the group consisting of cheese sauce, barbeque sauce, cream sauce, wine sauce, sour cream sauce, butter sauce, marshmallow sauce, tomato sauce, mustard sauce, garlic sauce, combinations thereof, and the like.

Preferably, the frozen potato pieces are packaged for microwave reheating. The package can be reheatable such that both the package and the enclosed potato pieces can be heated. Preferably, the package allows for steam reheating of the frozen potato pieces. Also preferably, the potato pieces are heated by microwave for about 3 minutes to about 15 minutes, and more preferably about 3 minutes to about 12 minutes. In other embodiments, the potato pieces are heated by microwave for about 3 minutes to about 10 minutes or about 3 minutes to about 9 minutes. After microwave heating, the potato pieces may be mashed by the consumer to form mashed potatoes.

### BRIEF DESCRIPTION OF THE DRAWING

FIG. 1 is a flow chart for an embodiment of a method of preparing mashable, freezable and/or reheatable potato pieces.

### DETAILED DESCRIPTION

As described herein, a method of making mashable, freezable and/or reheatable potato pieces is disclosed.

As used herein, the term “potato piece(s)” includes small, whole potatoes, as well as pieces of larger potatoes.

Suitable potatoes for use in the method 10 of making mashable potatoes include, without limitation, sweet potatoes, red-skinned potatoes, Yukon gold potatoes, russet potatoes, fingerling potatoes, Yellow Finn potatoes, new potatoes, white round potatoes, purple potatoes, Caribe potatoes, Idaho potatoes, Bintje potatoes, Red Pontiac potatoes, White Rose potatoes, Cherokee potatoes, Irish Cobbler potatoes, combinations thereof, and the like. Particularly preferred potatoes for use in the method 10 of making mashable potatoes include Russet Burbank, Russet Norkota, red-skinned, and sweet potatoes. The particular type of potato used in the process is not considered to be critical as long as the potato pieces used have structural integrity after cooking. The potatoes can be of varying degrees of floury (e.g., potatoes with a high starch content) and/or waxy (e.g. potatoes with a low starch content) consistency. In a preferred embodiment, the potatoes do not harden or get soupy and/or mushy during and/or after cooking.

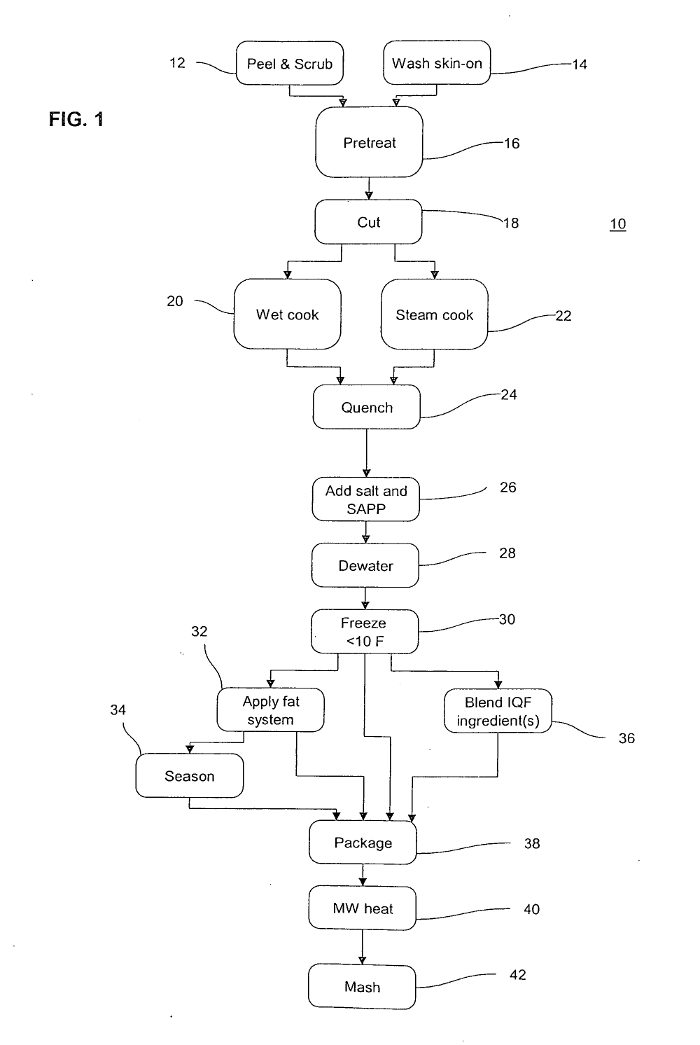

The first step of the preferred process depends upon whether the resulting product is to include the potato skin or not. Where skin will remain, the initial step 14 (see FIG. 1) involves washing the potatoes. Where the skin is not part of the resulting product, the potatoes are scrubbed and peeled 12. The potatoes can be scrubbed and washed before and/or after peeling. In a preferred embodiment, the potatoes are washed and/or scrubbed to remove any remaining dirt, pesticides, bacteria, fertilizer residue, and/or the like. The potatoes can be peeled using a knife, vegetable peeler, and/or a commercial peeling system, such as a Hobart Stainless Steel Potato Peeler manufactured by Hobart, Corp. of Troy, Ohio. Since some products may desirably include some potato skin material, the potatoes may be peeled to remove substantially all of the potato skin or only a portion of the potato skin.

Red-skinned potatoes are an example of potatoes that are washed and/or scrubbed 14, but not peeled prior to cooking. In the preferred embodiment, the skin-on potatoes are washed and/or scrubbed to remove any remaining dirt, pesticides, bacteria, fertilizer residue, and/or the like.

In the preferred embodiment, the washed and/or scrubbed potatoes are also inspected for imperfections, such as (i) eyes, (ii) rot, and/or (iii) brown, black or green spots. Potato pieces with such imperfections may be discarded or the imperfections may be cut out of the potatoes. In a preferred embodiment, the potato pieces can be inspected for eyes, spots, browning, and/or rot prior to cooking.

Optionally, the washed and/or scrubbed potatoes (peeled or skin-on) can be pretreated 16. Preferably, the pretreatment includes heating the washed and/or scrubbed potatoes for about 20 to about 35 minutes at about 120° F. to about 135° F. The pretreatment can take place via baking, broiling, steaming, boiling, blanching or other heating and cooking methods.

In the preferred embodiment, the washed and/or scrubbed potatoes (peeled or skin-on) are cut 18 into pieces that are substantially uniform in shape and size. If the potatoes are pre-treated, the potatoes are cut after pre-treatment. The potatoes can be cut by hand using a knife or by a commercial vegetable cutter. Preferably, the potatoes are cut into substantially uniform potato pieces so as to ensure even cooking. Preferably, the uniform potato pieces range in size from about ¼ inch to about 3 inches in length, about ¼ inch to about 3 inches in width, and about ¼ inch to about 3 inches in height. Also preferably, the potato pieces are cut in the form of discs, wedges, shreds, cubes, sticks, and the like.

In the preferred embodiment, the potato pieces are fully cooked by steaming, wet cooking, or other cooking methods. In the preferred embodiment, the potato pieces are wet cooked (e.g. cooking in hot water) 20. Preferably, the wet cooking step occurs at a temperature of about 175° F. to about 190° F. for about 8 minutes to about 40 minutes depending on the size of the potato pieces. Wet cooking temperatures above about 190° F. results in rupturing of starch cells and forms sticky and/or mushy potato pieces. Wet cooking temperatures below about 175° F. result in potato pieces that are hard and not as fluffy and/or mealy as potato pieces cooked at higher temperatures. For instance, potato cubes that are about ⅜ inch in size need only be cooked for about 8 minutes to about 20 minutes, whereas potato wedges that may be about 2 inches in size may require a cooking time of about 20 minutes to about 40 minutes. Preferably, the potato pieces are wet cooked at a temperature of about 175° F. to about 190° F. Typically, potato pieces having a higher starch content, such as russet potatoes, tend to fall apart when cooking due to the rupturing of the cells therein especially at temperatures above about 190° F. However, such rupturing of cells can occur at lower temperatures for potato pieces having a higher starch content. Thus, the combination of the cooking time and the cooking temperature depends on both the size of the potato pieces and on the type or variety of potato used, the age of the potato, storage conditions, water content of the potato, starch content of the potato and combinations thereof. The combination of time and temperature for the cooking step is selected so that, at the end of the cooking step, the potato pieces have structural integrity.

In another embodiment, the potato pieces may be steamed 22 at a temperature of about 200° F. to about 280° F. for about 5 minutes to about 10 minutes. As when wet cooking the potato pieces, the steaming time and temperature necessary to cook the potato pieces depends on the size of the potato pieces, as well as the type or variety of the potato and the starch content thereof. Not wishing to be bound by theory, it is believed that potatoes having a high starch content do not properly steam cook even within the 200° F. to 280° F. steam cooking temperature range.

In the preferred embodiment, the potato pieces are fully cooked until tender. Typically, the potato pieces are cooked past individual quick frozen (IQF) standard, which is typical for frozen food products. Typical frozen chunk potato pieces that meet the IQF standard have dimensions of about ½ inch by ½ inch by ½ inch and are wet cooked at about 176° F. to about 194° F. for about 2 to about 3 minutes. Thus, the potato pieces described herein must be cooked beyond that point to form frozen, reheatable, and/or mashable potatoes.

Also preferably, the potato pieces maintain structural integrity when cooked. As used herein, the term “structural integrity” describes cooked potato pieces that do not fall apart when handled, maintain the overall structure of the potato piece, but are tender and mashable. While the actual cooking mechanism is not presently fully understood, it is believed that the quantification of fully cooked until tender is satisfied when there is substantial maximization of starch granule swelling, while there is substantial minimization of cell wall rupture. Preferably, the potato pieces are not cooked so long that they gelatinize or become mushy.

Optionally, the method can include a step of quenching the potato pieces to cool to a core temperature lying in the range of about 40° F. to ambient (i.e. about 68° F.). If used, the quenching step for the potato pieces can be achieved by placing the potato pieces in cold water or room temperature water.

Once the potato pieces are cooked, sodium acid pyrophosphate (SAPP) 26 may be added thereto. SAPP can be added to control and substantially prevent iron oxidation of the potatoes and/or potato pieces. Typically, sufficient SAPP is added for complete prevention of iron oxidation in the potato pieces. Use of up to about 2% by weight of the potato pieces is ordinarily a sufficient amount of SAPP to accomplish complete prevention of iron oxidation. Thus, the SAPP prevents gray and/or off-colors in potatoes.

Salt can also be added 26 to the cooked potato pieces. The salt may function to flavor the potato pieces. The salt can be added in an amount of up to about 2.5% by weight of the potato pieces. In the preferred embodiment, salt is added in an amount of about 0.8% to about 1.0% by weight based on the weight of the potato pieces. In addition to flavoring the potato pieces, salt can also improve the smoothness of the resulting mashed potatoes. Typically, salt is not added to sweet potatoes for flavor.

In the preferred embodiment, the potato pieces are dewatered 28 after the cooking step. Preferably, the dewatering reduces the moisture content of the potato pieces to less than about 85%. The dewatering can be achieved by placing the potato pieces in a colander or other suitable commercial straining device. On a commercial scale, suitable conventional dewatering apparatus can be used. In an embodiment, the dewatering step can include drying the potato pieces. Typically, the dewatering step reduces water content to a level where potato pieces do not adhere to one another when subjected to freezing conditions.

Once the moisture content of the potato pieces is at a suitable level, the potato pieces are frozen 30. Preferably, the potato pieces are frozen to a temperature of less than about 10° F.

In the preferred embodiment, the potato pieces are cooked and frozen such that when heated in a microwave oven and subsequently mashed, the resulting mashed potatoes meet predetermined color, flavor, and texture requirements.

In the preferred embodiment, once heated and mashed, the potatoes have a substantially uniform color that can vary depending on the type of potato used. For example, red-skinned potatoes retaining some or all of the potato skins after cooking may have a substantially uniform slightly pinkish color throughout the potatoes after reheating and mashing, while Russet Norkota or Russet Burbank potatoes have a substantially uniform bright white to creamy white color throughout the potatoes after reheating and mashing. As used herein, the term “substantially uniform” is used to describe potatoes that show no mottling, spotting, color variation, or streaking after cooking, reheating and/or mashing as described herein.

Also preferably, the flavor and odor of the potatoes should have no off-flavors or odors of any kind. Specifically, the potatoes should have a noticeable salt level but should not be sour, moldy, bitter, rotten, green or dirty in flavor and/or odor.

In the preferred embodiment, the texture of the potato pieces after reheating and mashing should be such that, when heated and prepared as described below, there are less than about 5% lumps by weight of the finished mashed potatoes when the potatoes are strained through a standard US #7 sieve.

To determine whether the cooked and frozen potato pieces meet the color, flavor, and texture requirements, about 24 ounces of frozen potato pieces may be placed in a steaming pouch that is sealed. Alternatively, other freezer bags can contain the frozen potato pieces. When heating alternative freezer bags containing potato pieces, about 6 slits or vents, each about 0.25 inch long, can be made in the bag prior to heating. Preferably, the potato pieces are manipulated or arranged such that the potato pieces lie in substantially a single layer within the bag. The bag and enclosed potato pieces are placed in a 1200-watt microwave oven and heated on maximum power for about 10 minutes. After heating, the potato pieces stand or rest for 2 minutes, and are then removed from the microwave oven. After emptying the contents of the bag into a bowl, about 150 grams of water are added. The potato pieces and water are then mixed for about 1 minute with an electric mixer, such as a hand mixer, on the third speed setting (i.e., high speed setting). A standard US #7 sieve is then placed under running water, excess water is removed and the wet sieve is tared on a scale. The prepared, cooked, mashed potatoes are then placed in the sieve and the combined weight of the sieve and potatoes is recorded. The mashed potatoes are then rinsed under running water to wash away potato material that fits through holes in the sieve. When all of the soluble portion of the mashed potatoes has been washed away through the sieve, excess water is removed to a similar level as in the previous tared sieve. The sieve containing the remaining mashed potato lumps is then weighed. After subtracting the tared weight of the sieve from the measured weight of the potato lumps remaining in the sieve, the weight of the lumps is recorded and divided by the weight of the mashed potatoes after heating to determine the percent retained. The percent retained indicates how smooth the mashed potatoes are. Preferably, the mashed potatoes include less than 5% by weight lumps.

In contrast, frozen chunk potato pieces cooked to the IQF standard as described above (i.e. potato pieces having dimensions of about ½ inch by ½ inch by ½ inch and wet cooked at about 176° F. to about 194° F. for about 2 to about 3 minutes) can be mashed, but include about 16% to about 25% lumps. Thus, the frozen chunk potato pieces cooked only to the IQF standard do not meet the texture requirements of the frozen, reheatable, and/or mashable potato pieces which are cooked past the IQF standard.

To illustrate the improvement attained by the present process, (i) frozen chunk potato pieces meeting IQF standards and (ii) frozen potato pieces cooked past IQF standards were each reheated and mashed according to the same procedure. Specifically, each type of potato pieces was contained in a separate steam reheatable bag. Each bag was placed in a 1200-watt microwave oven and the potato pieces were manipulated or arranged such that the potato pieces were in substantially a single layer within the bag. The potato pieces were then heated on high for about 11 minutes and left to stand or rest for 1 minute in the microwave. Each bag was opened and emptied into a separate bowl. The reheated potato pieces were mashed slightly and about ¾ cups of 2% milk, which was first heated to 180° F. in the microwave, was added to each bowl. The potato pieces in each bowl were then mashed with a Sunbeam® 6 speed electric hand mixer for about 60 seconds on speed 3.

The texture of the resulting mashed potatoes was compared by trained evaluators (expert panelists). Each trained evaluator was given about 2 heaping tablespoons of each type of mashed potato. The potatoes were placed under a heat lamp to get hot. The panelists then evaluated the aroma when the potatoes reached a temperature of about 150° F. to about 160° F. The panelists evaluated the flavor when the potatoes reached a temperature of about 140° F. to about 150° F.

Finally, the trained evaluators used the standards Spectrum terminology for Descriptive Analysis and reference scales measuring attribute intensities using a 15 centimeter line scale to evaluate the texture. Spectrum is a Descriptive Analysis Method outlined in Sensory Evaluation Techniques, Fourth Edition by Morton C. Meilgaard, Gail Vance Civille, and B. Thomas Carr. Attributes are defined by the expert panelists and related to the “universal” scale that is the cornerstone to this method. The 15 centimeter line scale is a numerical type category scale anchored with store brand products that provide reference points, with a definition and procedure. For example, the following products score as follows on the Lumpiness Scale: 0 for snack chocolate pudding, 6.0 for tapioca pudding, 10.0 for San Giorgio® brand pasta and vanilla pudding, 14.0 for cottage cheese having small curds, and 15.0 for white rice, Long Grain.

The mean scores attributed to each product by the trained evaluators were analyzed by Duncan's Multiple Range test to determine and compare statistically significant differences (95% confidence) using SIMs2000 (Sensory Information Management System), available from Sensory Computer Systems, and SAS GLM software. Duncan's Multiple Range Test is one test used in SIMs2000 to indicate the significance of any differences between the samples, and is most commonly referred to as “mean separation analysis.” SIMs2000 is a software program that houses the evaluation ballots, sample inventory, and data. This software further provides various options for the analysis of sensory test data. SAS GLM is a software package used to run the statistical results (i.e. standard deviation, variance, p-value).

The results of the expert panelists' review are shown in Table 1 below.

TABLE 1

| | Frozen Potato | Frozen Chunk | |
|---|---|---|---|
| | Pieces cooked | Potato Pieces | |
| | past IQF | cooked to IQF | Confidence |
| | standard | standard | Level |
| Score for | Average 1.6 | Average 10.10 | 99.9% products |
| lumpiness of mash | | | are different |
| Scores for lump | Average 4.6 | Average 12.5 | 99.9% products |
| firmness | | | are different |
| Score for lump size | Average 3.2 | Average 11.0 | 99.9% products |
| | | | are different |
| Score for | Average 6.9 | Average 10.0 | 99.9% products |
| denseness of mash | | | are different |

After freezing the potato pieces, a fat system, seasoning and/or other IQF ingredients can optionally be added 36 to the frozen potato pieces and/or the potato pieces with or without the optional fat system can be packaged. After adding the optional fat system, seasoning and/or other IQF ingredients, the frozen potato pieces may then be packaged 38 for subsequent handling, distribution, sale, and reconstitution. Normally, microwave reconstitution by a consumer is contemplated for this product.

Suitable fat systems 32 contemplated for use in this process include, without limitation, butter, margarine, olive oil, sunflower oil, peanut oil, safflower oil, sesame oil, vegetable oil, chicken stock, beef stock, fish stock, lard, and combinations thereof.

The potato pieces can then be directly packaged 38 or optional additional seasonings 34 can be added before packaging. The seasoning step can introduce natural and/or artificial seasonings into the package. Suitable seasonings include, without limitation, salt, pepper, sugar, sugar substitutes, herbs, spices and/or flavored oils. Preferred herbs and spices include garlic, celery salt, paprika, chili powder, rosemary, thyme, oregano, dried mustard, mint, allspice, anise, basil, bay leaves, cayenne pepper, dill, cinnamon, cilantro, cloves, parsley, curry, fennel, chives, nutmeg, psyllium, sage, saffron, combinations thereof, and the like.

Also optionally, IQF ingredients 26 can be blended with the frozen potato pieces. Suitable IQF ingredients include, without limitation, proteins, sauces, vegetables and/or combinations thereof. Typical protein components include, without limitation, beef, chicken, fish, pork, soy protein, and/or shellfish. Suitable sauces include, without limitation, cheese sauce, barbeque sauce, cream sauce, wine sauce, marshmallow sauce, sour cream sauce, butter sauce, tomato sauce, mustard sauce, garlic sauce, combinations thereof, and/or the like. Suitable vegetables include, without limitation, onions, bell peppers, jalapeno peppers, habañero peppers, chili peppers, poblano peppers, snap peas, sugar peas, green peas, carrots, tomatoes, lettuce, cabbage, scallions, radishes, cucumbers, zucchini, yellow squash, butternut squash, summer squash, arugula, celery, cauliflower, spinach, beets, chickpeas, soybeans, butter beans, pumpkins, lentils, bean sprouts, asparagus, broccoli, brussel sprouts, green beans, kidney beans, pinto beans, navy beans, black beans, red beans, white beans, mushrooms, artichokes, Swiss chard, eggplant, combinations thereof, and/or the like.

Once the preferred fat system, seasoning and/or IQF ingredients are applied, the frozen potato pieces are ready to be packaged. In the preferred embodiment, the frozen potato pieces are placed in a microwave reheatable pouch or container that allows for steam reheating of the frozen potato pieces. Preferably, the container is in the form of a bag, box, bowl, or the like. The container can be made of paper, plastic, and/or microwaveable material suitable for use with foods. Preferably, the container is heat resistant so that the container can be placed in a microwave oven for reheating the frozen potato pieces therein. Preferably, the container retains moisture so that during microwave reheating moisture in the package will steam heat the potato pieces simultaneously with the microwave heating.

In use, a consumer can place a container of potato pieces in a microwave and heat 40 for a time period in the range of about 3 to about 15 minutes. In the preferred embodiment, this time period is in the range of about 3 minutes to about 12 minutes. In other embodiments, the time period is in the range of about 3 minutes to about 10 minutes or in the range of about 3 minutes to about 9 minutes. The heating time can depend on the amount of potato pieces being reheated and the type of potatoes being reheated. After heating, the potato pieces can be placed in a bowl or left in the container. Also after heating, the potato pieces are mashed 42 to create mashed potatoes. The consumer can add milk, sour cream, and/or other desirable ingredients to the mashed potatoes. Preferably, the potato pieces are fully mashed using a ricer, potato masher, mixer, fork, and/or other utensil. Rather than mashing the soft potato pieces, the potato pieces can be used to make potato salad.

In this specification, the word “about” is often used in connection with numerical values to indicate that mathematical precision of such values is not intended. Accordingly, it is intended that where “about” is used with a numerical value, a tolerance of 5% is contemplated for that numerical value.

While the foregoing describes in detail a preferred process for making mashable potato pieces with reference to a specific embodiment thereof, it will be apparent to one skilled in the art that various changes and modifications may be made to the process steps and equivalents to the process steps may be employed, which do not materially depart from the spirit and scope of the invention. Accordingly, all such changes, modifications, and equivalents that fall within the spirit and scope of the invention as defined by the appended claims are intended to be encompassed thereby.

We claim:

1. A method of making frozen, reheatable, and mashable potato pieces comprising:
cooking potato pieces such that said potato pieces retain structural integrity;
dewatering said potato pieces;
freezing said potato pieces to form frozen, reheatable, and mashable potato pieces; and
packaging said potato pieces in a reheatable container to form packaged frozen, reheatable, and mashable potato pieces.

2. The method of claim 1, wherein said potato pieces are peeled and/or partially peeled.

3. The method of claim 1, wherein said potato pieces are unpeeled.

4. The method of claim 1, further including applying at least one fat system to said frozen, reheatable, and mashable potato pieces.

5. The method of claim 4, wherein the at least one fat system is selected from the group consisting of butter, margarine, olive oil, vegetable oil, chicken stock, beef stock, fish stock, safflower oil, peanut oil, sesame oil, lard, sunflower oil and combinations thereof.

6. The method of claim 1, further including the step of washing and/or scrubbing said potatoes before the cooking step.

7. The method of claim 1, further including applying at least one seasoning to said frozen, reheatable, and mashable potato pieces.

8. The method of claim 7, wherein the at least one seasoning is selected from the group consisting of salt, pepper, sugar, sugar substitutes, garlic, herbs, spices, flavored oils, and combinations thereof.

9. The method of claim 1, further including the step of blending an individual quick frozen ingredient with said frozen, reheatable, and mashable potato pieces.

10. The method of claim 9, wherein said individual quick frozen ingredient is selected from the group consisting of a protein, a sauce, a vegetable and combinations thereof.

11. The method of claim 10, wherein said protein is selected from the group consisting beef, pork, chicken, soy protein, fish, shellfish, and combinations thereof.

12. The method of claim 10, wherein said sauce is selected from the group consisting of cheese sauce, barbeque sauce, cream sauce, wine sauce, marshmallow sauce, sour cream sauce, butter sauce, tomato sauce, mustard sauce, garlic sauce and combinations thereof.

13. The method of claim 10, wherein said vegetable is selected from the group consisting of onions, bell peppers, jalapeno peppers, habanero peppers, chili peppers, poblano peppers, snap peas, sugar peas, green peas, carrots, tomatoes, lettuce, cabbage, scallions, radishes, cucumbers, zucchini, yellow squash, butternut squash, summer squash, arugula, celery, cauliflower, spinach, beets, chickpeas, soybeans, butter beans, pumpkins, lentils, bean sprouts, asparagus, broccoli, brussel sprouts, green beans, kidney beans, pinto beans, navy beans, black beans, red beans, white beans, mushrooms, artichokes, Swiss chard, eggplant and combinations thereof.

14. The method of claim 1, wherein the potato pieces are cooked past the individual quick frozen standard.

15. The method of claim 1, including the further steps of heating the frozen, reheatable, and mashable potato pieces for about 3 to about 15 minutes to form heated potato pieces, and then mashing the heated potato pieces to form mashed potatoes.

16. The method of claim 1, wherein the freezing step includes lowering the temperature of the potato pieces to a temperature of less than about 10° F.

17. The method of claim 1, further including the step of cutting said potato pieces into substantially uniform potato pieces in the form of cubes, sticks, discs, wedges and combinations thereof.

18. The method of claim 17, wherein said substantially uniform potato pieces range in size from about ¼ inch to about 3 inches.

19. The method of claim 1, wherein said potato pieces are cooked in hot water or by steaming.

20. The method of claim 19, wherein the potato pieces are cooked in hot water at about 175° F. to about 190° F. for about 8 minutes to about 40 minutes.

21. The method of claim 19, wherein said potato pieces are steamed at about 200° F. to about 280° F. for about 5 minutes to about 10 minutes.

22. The method of claim 1, further including pretreating said potato pieces at a temperature of about 120° F. to about 135° F. for about 20 minutes to about 35 minutes.

23. The method of claim 1, further including quenching said potato pieces to a core temperature of about 40° F. to ambient.

24. The method of claim 1, further including adding salt in an amount of up to about 2.5% by weight of the potato pieces.

25. The method of claim 1, further including adding sodium acid pyrophosphate (SAPP) in an amount of up to about 2% by weight of the potato pieces.

26. The method of claim 1, wherein the potato pieces are pieces of one of Russet Burbank potatoes, Russet Norkota potatoes, Red-skinned potatoes, sweet potatoes and combinations of these.

27. The method of claim 1, wherein the potato pieces have less than about 5% lumps after reheating and mashing.

28. The method of claim 1, wherein the reheatable container is adapted to steam heat the potato pieces.

29. The method of claim 1, wherein the potato pieces have a substantially uniform color after reheating and mashing.
